(19) United States
(12) Patent Application Publication
(10) Pub. No.: US 2009/0133188 A1
(43) Pub. Date: May 28, 2009

(54) SPA JET WITH SCREW IN JET BARREL

(75) Inventors: Xue Wen PENG, Zhongshan City (CN); John KEIRSTEAD, Zhongshan City (CN); Kerry HARBARENKO, Zhongshan City (CN); Joe HOOVER, Zhongshan City (CN); Xue Wen LIU, Zhongshan City (CN)

Correspondence Address: HOLME ROBERTS & OWEN LLP, 1700 LINCOLN STREET, SUITE 4100, DENVER, CO, 80203, US

(73) Assignee: Zhongshan Rising Dragon Plastics Manufactuting Co. Ltd., Zhongshan City (CN)

(21) Appl. No.: 12/267,293

(22) Filed: Nov. 7, 2008

(30) Foreign Application Priority Data
Nov. 9, 2007 (CN) 200720059371.2

(51) Int. Cl. B05B 1/02; A47K 3/10

(52) U.S. Cl. 4/541.6; 239/101

(57) ABSTRACT

A jet assembly has internals rotatably and releaseably fit to a jet body, such as that for a spa. The internals have a barrel housing, a rotor and a barrel inlet. The internals as screwed into the jet body. A first threaded portion outside the barrel threadably engages second threaded portion inside the jet body wherein the internals have delimited rotation therein to align and misalign the barrel inlet from a body inlet on the jet body to control flow on and off respectively. The threaded portion within the jet body can be a locking ring affixed therein by fasteners or integral with the jet body. Rotation can be delimited by a projection on the barrel and a cooperating annular delimiting surface on the locking ring, such as circumferentially-spaced detents.

### FIELD OF THE INVENTION

The invention relates to spa jets used in spas, pools or any other hydrotherapy equipment and more particularly relates to spa jets having a jet barrel releasably and threadably affixed in a jet body.

### BACKGROUND OF THE INVENTION

A conventional jet assembly includes a removable jet internals including a face, a rotor, a barrel, and a barrel end piece. The jet internals are removeably fit to a jet body. A lock ring is installed inside the jet body. The face and barrel are fixed together. Spring clips extending from barrel join to the lock ring. Inlet ports on an end of the barrel cooperate with the jet body to enable on/off the flow when the jet internals are rotated. Further, air is automatically drawn in via an air-inlet port on jet body by a venturi action.

Currently, an existing problem with the conventional jet assemblies is that the jet internals, in particular the clips, tend to fail by popping out of the jet body over time due to continuous vibration, chemical corrosion, raw material limitations and high water pressure.

There is a need for an improved arrangement for releasably affixing the jet internals to the jet body.

### SUMMARY OF THE INVENTION

Generally, the present invention provides an improved rotatable connection between the jet internals and jet body that solves the aforementioned jet internal failure problems while continuing to enable full control of open/close of water flow by rotation of the jet internals.

In one aspect, the invention comprises a rotatable connection threadable connection between jet internals and a jet body. A jet assembly is provided comprising internals having a barrel housing, a rotor and a barrel inlet and having a jet body for receiving the internals. The jet body has a body inlet for introducing water flow. The barrel comprises a first threaded portion and the jet body comprises a second threaded portion wherein the barrel is screwed in or threadably connected to the jet body for delimited rotation of the barrel to align and misalign the barrel inlet from the body inlet to control flow on and off respectively.

A locking ring can be fit or integrated with the jet body which comprises the second threaded portion and means for delimiting the rotation, such as a projection on the barrel and one of more detents on in the locking ring.

In another aspect the invention comprises a jet assembly for a spa comprising a jet body adapted for support in a spa and having a body inlet for receiving a water flow and jet internals comprising a barrel housing, a rotor and a barrel inlet, the jet internals being rotatably connected within the jet body. A first threaded portion outside the barrel and a second threaded portion inside the jet body enable threadably connection to the jet body for delimited rotation of the barrel to align and misalign the barrel inlet from the body inlet to control flow on and off respectively.

### BRIEF DESCRIPTION OF THE DRAWINGS

FIG. 1 is an exploded perspective view of one embodiment of a spa jet including jet internals and the jet body;

FIG. 2 is a cross sectional view of the assembled jet according to FIG. 1;

FIG. 3 is a perspective view of a lock ring;

FIG. 4 is an exploded perspective view of another embodiment of a spa jet including jet internals and the jet body;

FIG. 5 is a perspective view a lock ring according to FIG. 4;

FIG. 6 is a perspective view of a jet barrel according to FIG. 1;

FIG. 7 is a perspective view of an embodiment of a jet body integrating the lock ring with the jet body;

FIG. 8 is a perspective view of an embodiment of a jet barrel according to FIG. 4; and

FIG. 9 is a perspective view another embodiment of a jet body.

### DETAILED DESCRIPTION OF THE PREFERRED EMBODIMENTS

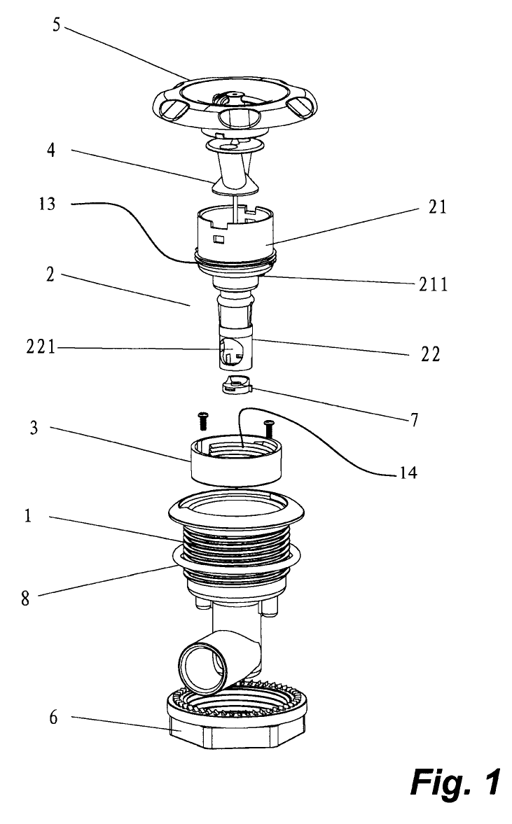

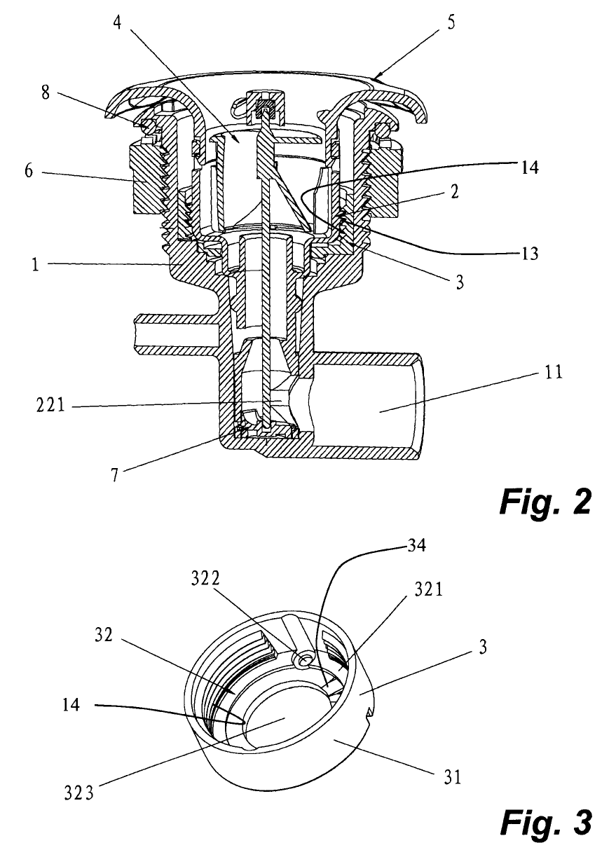

FIGS. 1 and 2 illustrate a spa jet having jet internals comprising face 5, rotor 4, barrel 2, and a barrel end piece 7. Further, the spa jet comprises a jet body 1 fit with a lock ring 3, the jet body being adapted for support in a spa by an O-ring 8 and nut 6. The lock ring 3 is installed in the jet body 1. The face 5 and the barrel 2 are fixed together. Barrel 2 comprises a barrel cavity 21 for housing a rotor 4 supported rotatably therein by means such as a spindle pin, and a lower inlet end 221 for receiving a flow of water from the jet body 1.

The jet internals are rotatably mounted within the jet body 1. A cooperating threaded connection having a first threaded portion 13 outside of the barrel 2 and a second threaded portion 14 inside the lock ring 3 for screwing in or rotatably securing the barrel 2 to the jet body 1. The first threaded portion 13 can be about the barrel cavity 21. Once threaded together, cooperating, rotational delimiting members on the barrel 2 and the jet body 1 delimit rotation between on (flowing) and off positions.

With reference to FIG. 3, one embodiment of the lock ring 3 comprises a tubular component having an annular ring 31 and a baseplate 32. The lock ring comprises a central passage 323 which allows the lower inlet end 221 of the barrel 2 to pass therethrough. The central passage formed with the second threaded portion 14. The baseplate 32 forms a shoulder or an annular delimiting surface, such as an annular groove 321, located axially below the second threaded portion 14, and further supports one or more screw holes 322 for connecting the lock ring 3 and the jet body 1. Screws (FIG. 1) through the screw holes 322 install the lock ring 3 in the jet body 1.

With reference to FIGS. 1, 3 and 6, there are one or more first delimiting members such as a directional projection 211 extending axially from an underside of the barrel cavity 21 for cooperating engagement with circumferentially-spaced and second delimiting members such as axially extending detents 34 of the annular groove 321 of the lock ring 3. It is understood that the first and second delimiting members on the barrel and jet body can be any one of cooperating projections/depressions, depressions/projection or projections/projections.

As shown, the first delimiting members are one or more axial projections or directional projections 211 and the second delimiting members are one or more detents 34 which rotationally position the barrel 2 relative to the jet body 1. The detents 34 are spaced circumferentially as stops or limits to control positioning of the barrel 2 and inlet end 221 for water control and extend axially to releasably engage the directional projection 211. In the embodiment of FIG. 1, the directional projection 211 is located axially below the first threaded portion 13 for cooperation with an annular delimiting surface located below the second threaded portion 14, such as on baseplate 32.

In use, the barrel 2 is rotated at the threaded connection to activate the jet. An example of such delimited rotation can be about ¼ turn between open and closed positions. As the barrel 2 is rotated, the directional projection 211 or catch moves circumferentially along the annular groove 321, and may engage one or more of the detents 34 formed therein, such as to orient the barrel inlet 221 to match the inlet 11 on the jet body 1 or to mismatch the barrel inlet to achieve an on/off function respectively. The barrel 2 may also be rotated to any intermediate and circumferential position therebetween.

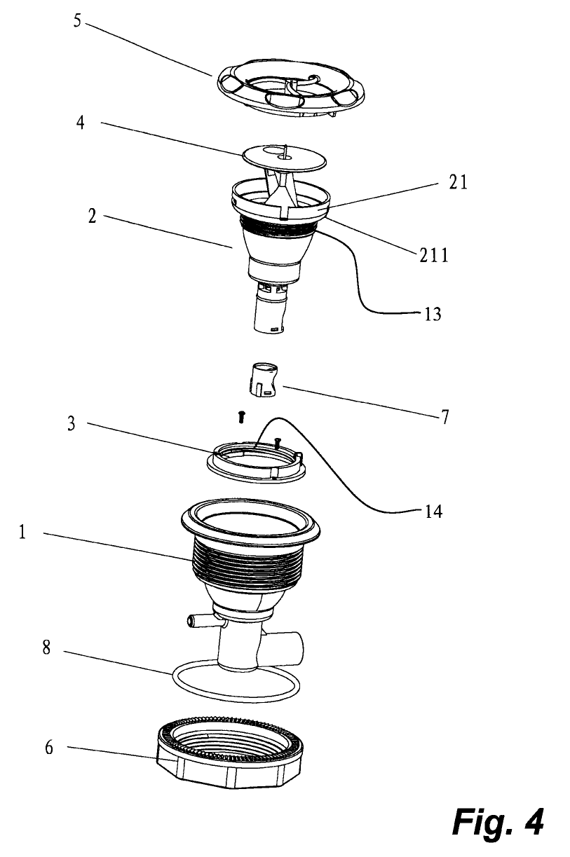

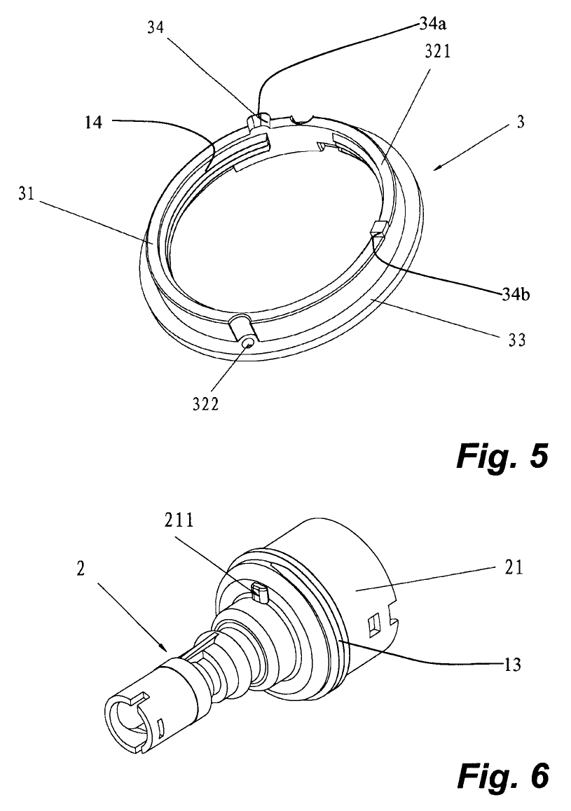

With reference to FIGS. 4, 5 and 8, in another embodiment, the lock ring 3 can be composed of an annular delimiting surface such as an annular ring 31 formed by an upper annular face 31f and a flange 33. The flange 33 is fit with screw holes 322 which enable using screws to install the lock ring 3 into the jet body 1 with the upper annular face 31f facing the barrel 2. The upper annular face 31f forms a counterpart to the annular groove 321 of the previous embodiment. In this embodiment, the directional projection 211 is located axially above the first threaded portion 13 for cooperation with the annular delimiting surface located above the second threaded portion 14, such as the upper annular face 31f.

The upper annular face 31f is fit with one or more detents 34 which, in this embodiment, protrude to extend axially. A cooperating directional projection 211 extends axially from an underside of the barrel cavity 21 for cooperating engagement with, and between, detents 34 of the upper annular face 31f of the lock ring 3 to control water on/off.

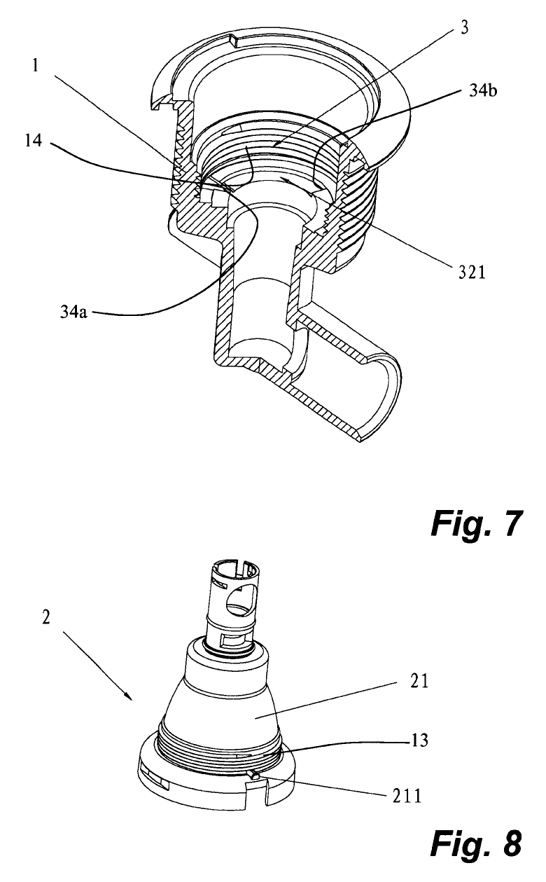

In another embodiment, and with reference to FIG. 7, the lock ring 3 and the jet body 1, according to FIG. 1, can be moulded together as a unitary assembly.

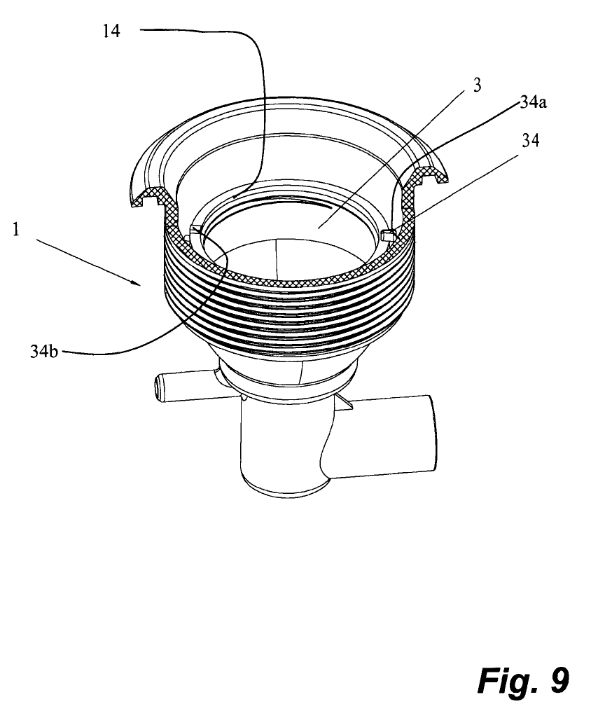

In another embodiment, and with reference to FIG. 9, the lock ring 3 and the jet body 1, according to FIG. 4, can be moulded together as a unitary assembly.

Assembly and Operation

As shown in either FIG. 1 or 4, to assemble a spa jet, a lock ring 3 is fit to the jet body 1, either by screws, mounted or formed therein. Typically, the jet body has already been pre-installed into a side wall of a spa tub. To install the barrel 2 in the jet body, the barrel 2 is threaded into the lock ring 3. As the barrel 2 is threaded deeper into the jet body 1, the directional projection 211 meets a detent 34 of the annular groove 321 or surface of the annular ring 31 (the annular delimiting surfaces of the first or second embodiment respectively, see FIGS. 1,4). The barrel is further threaded into the jet body 1 to let the directional projection 211 elastically engage and pass by a first detent 34a. This positions the barrel 2 into a rotationally adjustable position between a first detent 34a and a second detent 34b. Having passed by the first detent 31a, the barrel inlet 221 is initially positioned mismatched from the jet body inlet 11 and in the closed position.

A further delimited threaded rotation, such as between the two detents 34a,34b, orients the barrel inlet 221 to match with the jet body inlet 11 at which time the directional projection 211 engages the a second detent 34b in the full open position. The directional projection can move in the annular groove 321 or along the annular ring 31 between two detents 34a,34b to turn the flow on and off.

To remove the internals, the barrel is threaded out with sufficient strength to force directional projection 211 to cross the first detent 34a after which further un-threading permits removal of the internals. This design avoids a popping out of the internals by mispositioning.

The detents 34a,34b can be shaped to ease assembly and resist inadvertent disassembly. The first detent 34a has a directional function. During assembly, when the barrel's directional projection 211 first meets the first detent 34a, there is a ramp or slope to let it cross easily and access the annular groove 321 behind the first detent 34a which delimits the rotational movement. The first detent can have a perpendicular surface at the other side of the first detent 34a. Accordingly, as the internals are rotated within the annular groove 321, the directional projection 211 on the barrel 2 moves within the groove and is limited by the perpendicular surface of the first detent 34a. Accordingly, the disassembly of the barrel 2 from the jet body requires greater rotational force. This avoids inadvertent disassembly and pop out.

1. A jet assembly comprising internals having a barrel housing, a rotor and a barrel inlet and having a jet body for receiving the internals, the jet body having a body inlet, the jet assembly comprising:
a first threaded portion outside the barrel; and
a second threaded portion inside the jet body,
wherein the barrel is threadably connected to the jet body for delimited rotation of the barrel to align and misalign the barrel inlet from the body inlet to control flow on and off respectively.

2. The jet assembly of claim 1 further comprises
a first delimiting member on the barrel; and
a second delimiting member on the jet body,
wherein the first delimiting member cooperates with the second delimiting member for the delimited rotation of the barrel.

3. The jet assembly of claim 2 wherein
the first delimiting member is a projection; and
the second delimiting member is one or more detents.

4. The jet assembly of claim 1 further comprising a locking ring fit to the jet body, the locking ring forming the second threaded portion therein and further having an annular delimiting surface which cooperates with the barrel for delimited rotation of the barrel.

5. The jet assembly of claim 4 wherein the locking ring is fit to the jet body using fasteners or integrated into the jet body.

6. The jet assembly of claim 4 wherein the locking ring further comprises:
a tubular component having an annular ring, a baseplate and a central passage formed with the second threaded portion, wherein the annular delimiting surface is formed on the baseplate.

7. The jet assembly of claim 4 wherein the locking ring further comprises:
a tubular component having an annular ring and a central passage formed with the second threaded portion, wherein the annular delimiting surface is formed on the annular ring.

8. The jet assembly of claim 4 further comprising:
a first delimiting member forming an axial projection on the barrel;
a second delimiting member on the jet body, wherein the second delimiting member is the annular delimiting surface, the annular delimiting surface further comprising circumferentially-spaced detents wherein the first delimiting member cooperates with the second delimiting member for the delimited rotation of the barrel.

9. The jet assembly of claim 8 wherein:
the axial projection is located axially below the first threaded portion; and
the annular delimiting surface is located axially below the second threaded portion.

10. The jet assembly of claim 8 wherein:
the axial projection is located axially above the first threaded portion; and
the annular delimiting surface is located axially above the second threaded portion.

11. A jet assembly for a spa comprising:
a jet body adapted for support in the spa and having a body inlet for receiving a water flow;
jet internals comprising a barrel housing, a rotor and a barrel inlet, the jet internals being rotatably connected within the jet body;
a first threaded portion outside the barrel; and
a second threaded portion inside the jet body,
wherein the barrel is threadably connected to the jet body for delimited rotation of the barrel to align and misalign the barrel inlet from the body inlet to control flow on and off respectively.

12. The jet assembly of claim 11 further comprises:
a first delimiting member forming a projection on the barrel; and
a second delimiting member on the jet body,
wherein the projection cooperates with the second delimiting member for the delimited rotation of the barrel.

13. The jet assembly of claim 12 wherein the second delimiting member is one or more detents.

14. The jet assembly of claim 12 further comprising a locking ring fit to the jet body, the locking ring forming the second threaded portion therein and further having an annular delimiting surface which cooperates with the barrel for delimited rotation of the barrel.

15. The jet assembly of claim 14 wherein the locking ring is fit to the jet body using fasteners or integrated into the jet body.

16. The jet assembly of claim 14 wherein the locking ring further comprises:
a tubular component having an annular ring, a baseplate and a central passage formed with the second threaded portion, wherein the annular delimiting surface is formed on the baseplate.

17. The jet assembly of claim 14 wherein the locking ring further comprises:
a tubular component having an annular ring and a central passage formed with the second threaded portion, wherein the annular delimiting surface is formed on the annular ring.

18. The jet assembly of claim 14 further comprising:
a first delimiting member forming an axial projection on the barrel;
a second delimiting member on the jet body, wherein the second delimiting member is the annular delimiting surface, the annular delimiting surface further comprising circumferentially-spaced detents wherein the first delimiting member cooperates with the second delimiting member for the delimited rotation of the barrel.

19. The jet assembly of claim 18 wherein:
the axial projection is located axially below the first threaded portion; and
the annular delimiting surface is located axially below the second threaded portion.

20. The jet assembly of claim 18 wherein:
the axial projection is located axially above the first threaded portion; and
the annular delimiting surface is located axially above the second threaded portion.
